(19) United States
(12) Patent Application Publication
(10) Pub. No.: US 2011/0200393 A1
(43) Pub. Date: Aug. 18, 2011

(54) INTERVENTION METHOD AND APPARATUS

(76) Inventors: Nicholas John Ryan, Aberdeen (GB); John Marsden, Aberdeen (GB); Stuart Mitchell, Aberdeen (GB); Peter David Alexander, Aberdeen (GB)

(21) Appl. No.: 12/934,523

(22) PCT Filed: Mar. 25, 2009
(86) PCT No.: PCT/GB09/50288

§ 371 Date: Mar. 7, 2011

(30) Foreign Application Priority Data
Mar. 25, 2008 (GB) 0805343.1

(51) Int. Cl. F16L 55/18

(52) U.S. Cl. 405/184.1

(57) ABSTRACT

The present invention describes an apparatus (1) for establishing a subsea environment to enable an intervention operation to be carried out on a pipe, the apparatus comprising a frame (2) adapted to abut an outer surface of the pipe, sealing means (7) to enable the frame to be sealed against the surface of a pipe, and means for monitoring the condition of the seal, wherein the environment is established between the frame and the surface of the pipe and further describes a method of establishing a subsea environment to enable an intervention operation to be carried out on a pipe, the method comprising the steps of deploying a frame (2) subsea, locating the frame against the side of a pipe to establish the environment between the frame and the pipe, sealing the frame against the side of the pipe, and monitoring the condition of the seal.

The present invention relates to an intervention method and apparatus and more particularly to an intervention method and apparatus for replacing an element in the side wall of a tubular member. More specifically still, the present invention relates to a method and apparatus for replacing a valve, plug or other component in the side wall of a pipe, most particularly a flexible pipe in a pipeline or end fitting of a flexible pipe.

Pipelines are routinely used for transporting materials such as fluids and particularly hydrocarbons including liquids and gasses over large distances. This may be between an offshore facility such as a well and an offshore processing plant.

The pipeline is generally formed of discrete sections of pipe which are connected together end to end to form a continuous path for the materials to flow. Flexible Pipe is a term used to describe a multi layered pipe which is formed from materials which allow it to bend relatively easily. It is generally constructed of various layers of materials such as polymers and metals or composites.

Flexible pipes are used throughout the oil and gas industry both onshore and predominately offshore. Their attraction is the ease of installation and their ability to withstand cyclic bending, and therefore they are less prone to fatigue than rigid risers.

The internal bore of a flexible pipe can be smooth or rough.

The carcass represents the innermost layer of a typical flexible pipe and prevents the pipe from collapsing under external hydrostatic pressure. The carcass is formed of interlocked wires in the form of a folded interlocked flat metal which provides stability and resists collapse whilst remaining flexible. The carcass also presents a corrugated surface which allows fluids flowing in the pipe to seep through the carcass.

An internal pressure sheath surrounds the carcass and acts as a boundary for conveyed fluids within the pipe. The pressure sheath is generally formed by a thermoplastic inner fluid barrier and provides a seal to prevent internal fluid flowing in the pipeline from escaping from the inner carcass.

A pressure armour is formed around the outer surface of the internal pressure sheath and provides hoop strength to the pipeline to resist internal and external hoopwise pressure which could otherwise cause the pipe to collapse.

A helically wound tensile armour formed of rectangular or round wire or composite rods is provided over the pressure armour to provide axial support and to support the hoop strength of the pipeline.

A thermal insulating layer covers the tensile armour to protect the pipe against heat loss from the fluids flowing within the pipe and an outer sheath of thermoplastics surrounds the pipe to protect against seawater ingress and material damage to the surface of the pipe.

The space between the inner carcass and the internal pressure sheath is known as the annulus. As noted above, when fluids such as liquid or gaseous hydrocarbons flow in such a flexible pipe, the gasses in the bore permeate through the pressure sheath and into the annulus. Means must be provided to vent the gases from the annulus otherwise the outer sheath may rupture as a result of the build up of pressure within the pipe. Such a rupture will in turn cause sea water to flood the annulus which will affect the integrity of the pipe. A common failure mode in flexible pipelines is due to sea water flooding the annulus.

Currently, venting means are provided by a valve mounted in the side wall of an end fitting which may be provided at the end of each pipe within the pipeline and is used to join the end of a first pipe to the end of a second pipe within the pipeline.

One of the main causes of pressure build or leakage into the annulus is through faulty vent valves or vent plugs respectively. Vent plugs may be used where venting is not required or desired.

Currently, the only method of replacing a faulty valve or plug subsea is to remove the pipe from the seabed and replace the faulty fitting. This is very expensive in terms of shut down and vessel time required for the operation and a method for replacement of the valve or plug which can avoid these problems whereby flooding of the annulus is avoided is highly desirable.

It is therefore an aim of the present invention to provide a method for replacement of an element such as a valve or plug in a flexible pipeline which addresses the above problems.

It is a further aim of the present invention to provide an apparatus for replacement in an element such as a valve or plug in a flexible pipeline which addresses the above problems.

According to a one aspect of the present invention there is provided an apparatus for establishing a subsea environment to enable an intervention operation to be carried out on a pipe, the apparatus comprising a frame adapted to abut an outer surface of the pipe, sealing means to enable the frame to be sealed against the surface of a pipe, and means for monitoring the condition of the seal, wherein the environment is established between the frame and the surface of the pipe.

Preferably the apparatus further comprises means for venting air or water from the frame to isolate the environment within the frame from that surrounding environment.

Preferably also, the apparatus further comprises means for controlling the isolated environment within the frame.

Preferably the apparatus further comprises a cartridge for storing elements used during the intervention operation.

Advantageously the apparatus further comprises a driving tool extendible through the cartridge to transfer elements between the cartridge and the pipe.

Preferably the cartridge is rotatably mounted within the frame.

Preferably also the cartridge is adapted to store vent valves or plugs.

Advantageously the cartridge is mounted on a spindle which extends through the frame to allow the cartridge to be rotated externally of the frame.

Preferably the spindle extends through an aperture in the frame.

Advantageously sealing means are provided between the spindle and the frame.

Conveniently the driving tool is advance able through an aperture in the frame.

Preferably sealing means are provided between the driving tool and the frame.

Preferably the sealing means on the frame comprises at least two resilient seals.

Preferably the resilient seals are gaskets or o-rings.

Preferably also, the sealing means further comprises a reservoir for storing a sealing solution, said reservoir having an outlet between the two resilient seals.

Preferably the sealing solution comprises a solution of discrete sealing elements.

Advantageously the discrete sealing elements comprise polymeric or elastomeric materials.

Preferably the apparatus further comprises means for pressurizing the solution of the discrete sealing elements within the reservoir to force the sealing elements against the surface of the pipe between the two resilient seals.

Conveniently the apparatus further comprises means for venting air and water from the frame.

Advantageously said venting means comprises a nitrogen supply which is connectable to the frame via a port and means for pumping said nitrogen into the frame.

Preferably the frame comprises a further port to vent air and water from the frame.

According to a further aspect of the present invention there is provided a method of establishing a subsea environment to enable an intervention operation to be carried out on a pipe, the method comprising the steps of deploying a frame subsea, locating the frame against the side of a pipe to establish the environment between the frame and the pipe, sealing the frame against the side of the pipe, and monitoring the condition of the seal.

Preferably the method further comprises the step of venting air or water from the frame to isolate the environment within the frame from that surrounding environment.

Preferably also, the method further comprises the step of controlling the isolated environment within the frame.

Preferably the method further comprises the step of providing a cartridge within the frame for storing elements used in the intervention operation.

Preferably also, the method further comprises the step of advancing a driving tool through the cartridge to transfer and element between the cartridge and the pipe.

Advantageously the method further includes the step of storing a replaced element in the cartridge.

Preferably the step of venting air and water from the frame comprises pumping nitrogen into the frame.

Advantageously the method further includes the step of securing the frame to the side of a pipe.

Preferably the method further includes the step of forming a pressure seal between the frame and the side wall of the pipe to prevent water ingress into the frame during the replacement operation.

Advantageously the pressure seal is formed by forcing a sealing solution and more preferably a solution of discrete sealing elements against the side of the pipe and maintaining the seal by maintaining the pressure of the sealing elements against the side of the pipe.

Preferably the pressure of the sealing solution is monitored to provide real time feedback on the condition of the seal.

Conveniently the method further includes the step of providing a nitrogen supply subsea.

One embodiment of the present invention will now be described with reference to the accompanying drawings in which:—

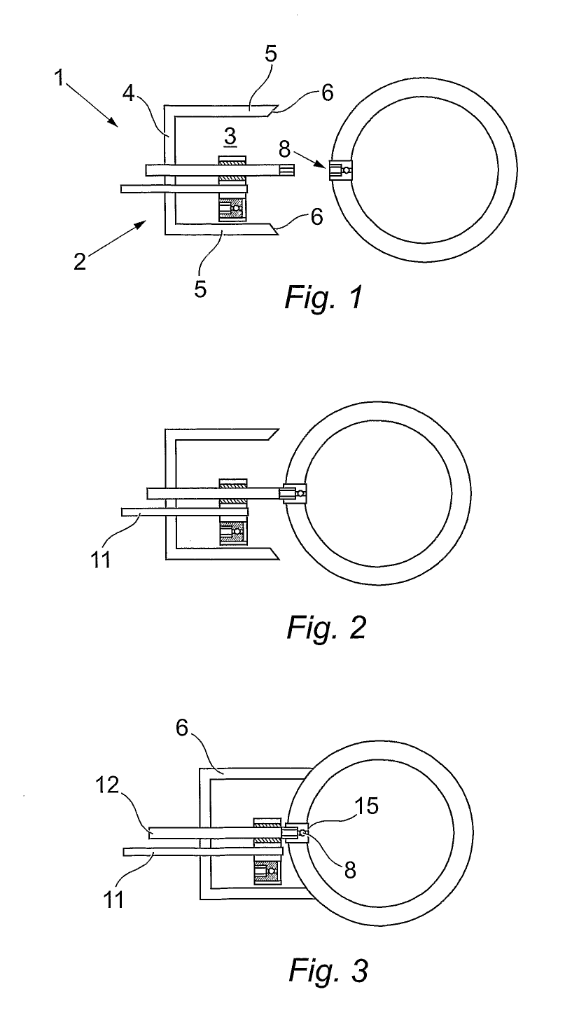

FIG. 1 is a schematic view of an apparatus according to one aspect of the present invention approaching a pipe with a faulty valve;

FIG. 2 is a schematic view of the apparatus of FIG. 1 being centred on the faulty valve;

FIG. 3 is a schematic view of the apparatus of FIG. 1 mounted on the side of the pipe;

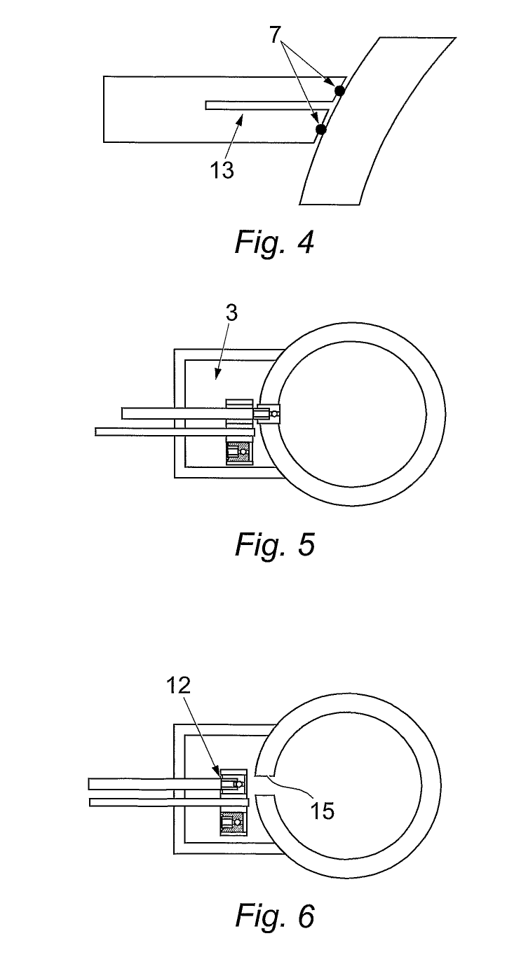

FIG. 4 is a schematic enlarged view of an upper edge of a side wall of the frame showing the sealing means between the frame and the pipe wall;

FIG. 5 is a schematic view of the apparatus during recovery of the faulty valve;

FIG. 6 is a schematic view of the apparatus showing storage of the faulty valve within the frame;

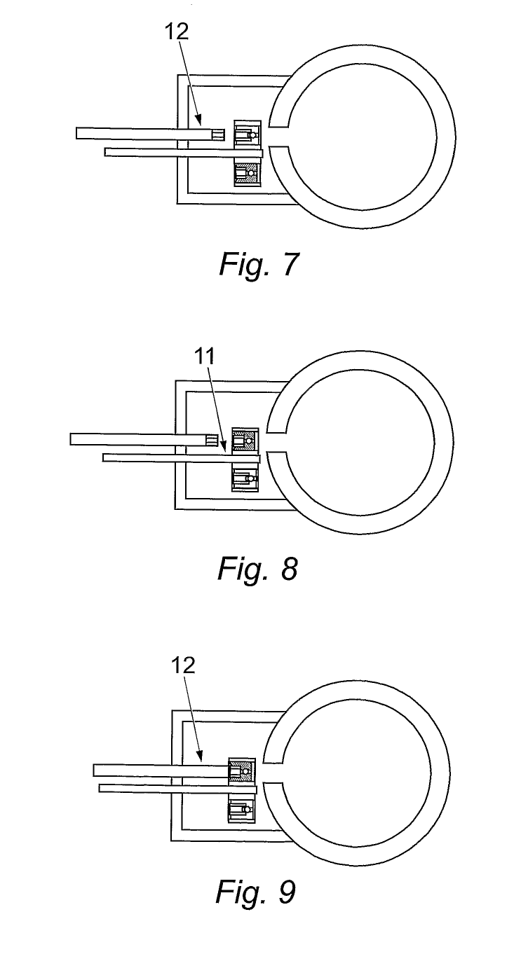

FIG. 7 is a schematic view of the apparatus with the faulty valve stored and the driving tool withdrawn;

FIG. 8 is a schematic view of the apparatus with a replacement valve aligned with the valve seat in the pipe;

FIG. 9 is a schematic view of the apparatus with the driving tool engaging the replacement valve;

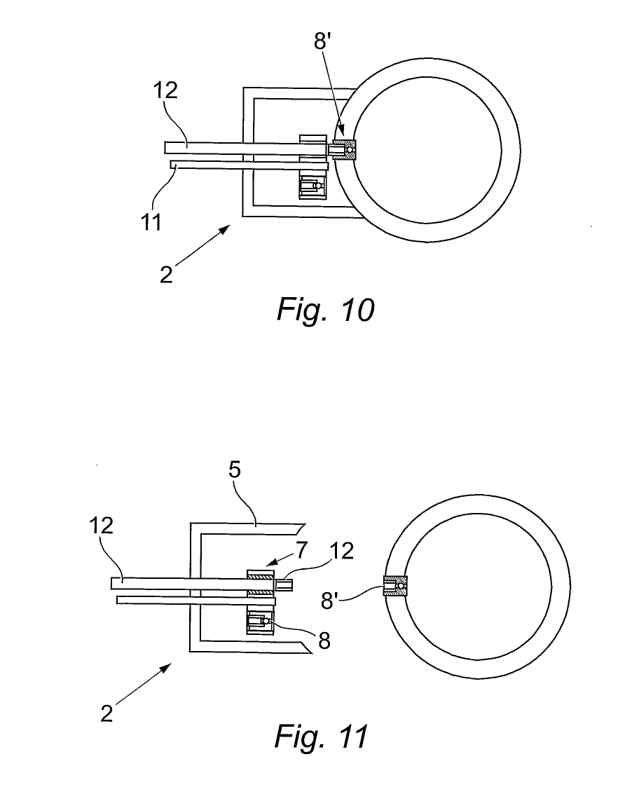

FIG. 10 is a schematic view of the apparatus with the driving tool advancing the replacement valve towards the valve seat, and

FIG. 11 is a schematic view showing the apparatus being removed from the pipe with the replacement valve in place.

Turning now to the figures, there is shown in FIG. 1 an apparatus 1 for facilitation intervention in a pipe, said apparatus comprising a substantially hollow frame 2. In the embodiment shown, the frame defines a receptacle 3 with a substantially planar base 4 and substantially planar opposing sides 5 and opposing ends (not shown).

The upper edges 6 of each side 5 and each end of the frame are chamfered such that when the frame is advanced toward the side wall of a pipe the edges of the sides follow the curvature of the outer surface of an end fitting of the pipe and the frame abuts the outer surface of the pipe.

Elastomer seals 7 are provided on the upper edges 6 of each side and end of the frame. The seals are shown in FIG. 4. Each side 5 is provided with two elastomer seals which may take the form of a rubber or other non-corrosive resilient member which is either provided on the upper edge 6 or mounted within a groove on the upper edge of the sides of the frame.

The frame is preferably formed of a non-corrosive alloy material such as duplex or titanium to enable the frame to be used subsea for pipe intervention.

A support cartridge 7 is provided within the frame 2, between the two sides 5. The cartridge is adapted to support a plurality of vent valves 8 for mounting in an end fitting of a pipe. In the illustrated embodiment the support cartridge comprises a body 9 which in this embodiment has two discrete compartments 10 to store valves in a tight fit relationship.

Alternatively the valves 8 may be held in the compartments by any known means such as for example, push fit mounting, co-operating screw threads on the outer surface of the valve and the inner surface of the cartridge or a locally applied adhesive within the cartridge.

The cartridge 7 is mounted on a spindle 11 which extends through an aperture in the base 4 of the frame. The spindle is rotatable to allow each compartment 10 in the cartridge to be lined up with the centre of the frame.

A seal (not shown) is provided around the spindle 11 as it passes through the base plate 4 of the frame to prevent water ingress between the spindle and the base plate.

A tool 12 suitable for removing and mounting vent valves is advance able through a further aperture 4 in the end plate of the frame. Preferably the tool is a hexagonal driving tool. The tool passes substantially through the centre of the frame 2 between the two sides 5. In some embodiments the tool may be integrally formed with the frame. In other embodiments the tool is mounted through the frame and sealed in position to prevent water ingress into the frame when it is sealed against the side of a pipe.

In all embodiments, the tool 12 is advanceable within the frame 2, through a selected compartment 10 of the valve cartridge 7 as will be described further below.

Means (not shown) are provided for pumping nitrogen or another fluid into the frame as will be described further below.

A reservoir 13 is provided in each side of the frame. The reservoir is shown in FIG. 4. The reservoir is adapted to hold a pressurised solution of discrete sealing elements as will be described further below. An outlet 14 is defined for each reservoir adjacent the upper edge 6 of the side of the frame 5 between the two elastomer seals 7.

Attachment means (not shown) are provided for mounting the frame 2 on the side of a pipe. The attachment means may be a series of clamps, bands or straps which pass around the pipe and service to anchor the frame on the pipe.

The use of the apparatus will now be described. When a faulty valve 8 is reported a replacement valve is mounted within one of the compartments 10 in the cartridge 7 and the frame 2 is deployed subsea either by divers or using an ROV.

The frame 2 is aligned with the faulty valve 8 in the end fitting of the pipe such that advancement of the driving tool 12 through the frame will bring the driving tool into engagement with the valve 8. Thus the driving tool acts as a centring device for the frame before it is mounted to the side wall of a pipe.

Once the driving tool 12 is centred on the faulty valve 8, the frame can be advanced towards the side wall of the end fitting of the pipe until it abuts the pipe. The frame 2 is then attached to the side of the pipe using the attachment means.

With the edges 6 of the sides of the frame in contact with the side wall of the end fitting, the sealing means 7 on the edges of the sides of the frame are compressed between the edges 6 and the outer surface of the pipe and provide a seal against water ingress into the frame.

Once the seal is established, the solution of discrete sealing elements is forced from the reservoirs 13 under pressure from an external pressure source against the side of the pipe through the outlet 14 between the two resilient seals 7. The sealing elements spread between the two resilient seals and provide a backup seal which forms a pressure barrier against water ingress into the frame.

Any loss in pressure between the resilient seals will reflect a leakage of sealing elements and this allows the integrity of the seal between the frame and the pipe to be monitored during the intervention operation. A device such as a pressure gauge may be mounted on the frame or may alternatively be provided remotely for example on a surface vessel from where the monitoring is undertaken.

In the preferred embodiment nitrogen is then pumped into the sealed frame through one or more valves (not shown) to replace the air and water within the frame and to isolate the environment within the frame from the surrounding environment. The isolated environment can be controlled either from the surface or locally such that additional nitrogen can be pumped into the frame if necessary. The pumping means may comprise a nitrogen source located on the surface or on or adjacent the frame, one or more gas or fluid carrying lines which can be connected to a vent on the frame and a pump for transferring fluids between the source and the frame.

The spindle 11 is rotated within the frame 2 to rotate the cartridge 7 such that an empty compartment 10 is lined up with the centre of the frame.

Once the frame 2 is purged of water the driving tool 12 is advanced through the empty compartment 10 of the cartridge in the centre of the frame and engages the faulty valve 8. The driving tool is operated to remove the valve from the end fitting and both the driving tool 12 and the faulty valve 8 mounted on the end of the tool are withdrawn within the frame until the faulty valve is securely located within the empty compartment 10 of the valve cartridge 7.

At this point of the operation, the annulus of the pipe is breached by removal of the faulty valve 8 and the pressure within the annulus equalises with the pressure within the sealed frame, As the frame 2 completely covers the access aperture for the valve and the seals around the upper edges of the frame prevent any water ingress into the annulus, the removal of the valve with the pipe in situ does not compromise the integrity of the pipe.

With the faulty valve 8 secured within the compartment 10 of the cartridge 7, the driving tool is disengaged from the valve and withdrawn from the cartridge.

The spindle 11 is then rotated to rotate the cartridges 10 within the frame to bring the compartment with the replacement valve 8′ into registry with the centre of the frame. The replacement valve is now lined up with the driving tool 12 and the valve seat 15 in the side fitting of the pipe.

The driving tool 12 is advanced through the cartridge 10 and engages with the replacement valve 8′. The driving tool and the replacement valve are then advanced towards the side wall of the end fitting and the replacement valve is installed in the valve seat 15 within the end fitting.

Tests can be carried out with the frame in situ on the side wall of the end fitting to ensure that the replacement valve 8′ seals the side wall. In one embodiment a pressure test can be carried out with nitrogen to ensure that when the frame is removed there will be no water ingress into the annulus through the replacement valve.

Once the integrity of the replaced valve is confirmed, the pressure seals provided by the discrete sealing elements around the upper edges 6 of the frame can be released by reducing the pressure within the reservoirs 13 in the sides of the frame. The attachment means can be released and the frame can then be removed from the side wall of the end fitting and any nitrogen remaining within the frame is vented to the surrounding water.

The frame 2 can then be recovered to the surface either by divers or by ROV.

In some embodiments of the present invention the pressure seal between the frame and the pipe may comprise a setting gel or bonding material such as an epoxy or elastomer material. In one embodiment a catalyst may be provided to set the gel around the sealing elements. In some embodiments a setting gel or bonding material may be provided between the resilient seals in advance of a solution of discreet sealing elements. In other embodiments further setting gel or bonding material may be forced between the resilient seals after an initial charge of setting gel or bonding material is used without providing discreet sealing elements.

The present invention provides a simple and effective apparatus and method for replacing a faulty valve particularly in an end fitting of a flexible pipe in situ which represents a significant cost and time saving to the industry. As soon as a faulty valve is detected, steps can be taken to replace the valve without recovery of the pipe to the surface.

The seals around the upper edges of the sides of the frame allow the frame to be used with a range of different diameter pipes and pipe end fittings.

It will be appreciated that the apparatus of the invention can be reused and can, for example, be adapted to allow additional valve replacements to be carried out on a single subsea operation. In this embodiment, the valve cartridge 7 within the frame may be provided with additional compartments 10 such that further replacement valves can be carried within the frame.

The apparatus is of a compact nature which enables it to be carried on a floating vessel or platform without taking up significant storage space. Furthermore, the lightweight nature of the apparatus ensures that it can be carried on such vessels without undue consideration.

Additionally, as the frame of the apparatus abuts against a side wall of the pipe in order to establish a subsea environment between the frame and the wall of the pipe without requiring the frame to completely surround or enclose the pipe, intervention operations can be carried out with minimal disturbance to the pipe. Also, as the frame does not surround the pipe, there is no need for additional equipment to lift a heavy pipe from the sea bed for example in order to place a jacket or collar around the pipe. Therefore the intervention operation can be carried out in previously considered difficult to reach areas and in a more cost effective manner.

The present invention has been described particularly in relation to replacement of faulty vent valves in pipe end fittings but is it envisaged that the invention may also be used to replace other faulty components in a similar fashion without requiring recovery of the pipe to the surface.

The present invention can also be used in a hot tapping operation where direct means for intervening in the pipe is required. It can be used on anything where an environmental seal is desirable whilst sealing in a failsafe manner using a pressure seal. A hot tap would typically require a weldment to establish a seal and then the intervention into the pipeline would be made through the weldment and attached valves. The apparatus as described above requires no welding and when the apparatus is removed nothing is left behind that could potentially fail or be knocked off the pipe in the future. Therefore use of the device as described quicker and easier than welding a device to the pipe.

1. An apparatus for establishing a subsea environment to enable an intervention operation to be carried out on a pipe, the apparatus comprising:
a frame adapted to abut an outer surface of the pipe;
sealing means to enable the frame to be sealed against the surface of a pipe;
means for monitoring the condition of the seal; and
wherein the environment is established between the frame and the surface of the pipe.

2. An apparatus according to claim 1, wherein the apparatus further comprises means for venting air or water from the frame to isolate the environment within the frame from that surrounding environment.

3. An apparatus according to claim 2, wherein the apparatus further comprises means for controlling the isolated environment within the frame.

4. An apparatus according to claim 1, wherein the apparatus further comprises a cartridge for storing elements used during the intervention operation.

5. An apparatus according to claim 4, wherein the apparatus further comprises a driving tool extendible through the cartridge to transfer elements between the cartridge and the pipe.

6. An apparatus according to claim 4, wherein the cartridge is rotatably mounted within the frame.

7. An apparatus according to claim 4, wherein the cartridge is adapted to store vent valves or plugs.

8. An apparatus according to claim 4, wherein the cartridge is mounted on a spindle which extends through the frame to allow the cartridge to be rotated externally of the frame.

9. An apparatus according to claim 8, wherein the spindle extends through an aperture in the frame.

10. An apparatus according to claim 1, wherein a second sealing means is provided between the spindle and the frame.

11. An apparatus according to claim 5, wherein the driving tool is advance able through an aperture in the frame.

12. An apparatus according to claim 11, wherein a second sealing means is provided between the driving tool and the frame.

13. An apparatus according to claim 1, wherein the sealing means is provided on the frame and comprises at least two resilient seals.

14. An apparatus according to claim 13, wherein the resilient seals are gaskets or o-rings.

15. An apparatus according to claim 13, wherein the sealing means further comprises a reservoir for storing a sealing solution, said reservoir having an outlet between the two resilient seals.

16. An apparatus according to claim 15, wherein the sealing solution comprises a solution of discrete sealing elements.

17. An apparatus according to claim 16, wherein the discrete sealing elements comprise polymeric or elastomehc materials.

18. An apparatus according to claim 16, wherein the apparatus further comprises means for pressurizing the solution of the discrete sealing elements within the reservoir to force the sealing elements against the surface of the pipe between the two resilient seals.

19. An apparatus according to claim 2, wherein said venting means comprises a nitrogen supply which is connectable to the frame via a port and means for pumping said nitrogen into the frame.

20. (canceled)

21. A method of establishing a subsea environment to enable an intervention operation to be carried out on a pipe, the method comprising:
deploying a frame subsea;
locating the frame against the side of a pipe to establish the environment between the frame and the pipe;
sealing the frame against the side of the pipe; and
monitoring the condition of the seal.

22. A method according to claim 21, wherein the method further comprises venting air or water from the frame to isolate the environment within the frame from that surrounding environment.

23. A method according to claim 22, wherein the method further comprises controlling the isolated environment within the frame.

24. A method according to claim 21, wherein the method further comprises providing a cartridge within the frame for storing elements used in the intervention operation.

25. A method according to claim 24, wherein the method further comprises advancing a driving tool through the cartridge to transfer an element between the cartridge and the pipe.

26. A method according to claim 25, wherein the method further comprises storing a replaced element in the cartridge.

27. A method according to claim 22, wherein the step of venting air and water from the frame comprises pumping nitrogen into the frame.

28. A method according to claim 21, wherein the method further comprises securing the frame to the side of a pipe.

29. A method according to claim 21, wherein the method further comprises forming a pressure seal between the frame and the side wall of the pipe to prevent water ingress into the frame during the replacement operation.

30. A method according to claim 29, wherein the pressure seal is formed by forcing a sealing solution and more preferably a solution of discrete sealing elements against the side of the pipe and maintaining the seal by maintaining the pressure of the sealing elements against the side of the pipe.

31. A method according to claim 29, wherein the pressure of the sealing solution is monitored to provide real time feedback on the condition of the seal.

32. A method according to claim 21, wherein the method further comprises providing a nitrogen supply subsea.

33. (canceled)
